(19) United States
(12) Patent Application Publication
(10) Pub. No.: US 2013/0034361 A1
(43) Pub. Date: Feb. 7, 2013

(54) IMAGE HEATING APPARATUS

(71) Applicant: Akiyoshi Shinagawa, Kashiwa-shi (JP)

(72) Inventor: Akiyoshi Shinagawa, Kashiwa-shi (JP)

(73) Assignee: CANON KABUSHIKI KAISHA, Tokyo (JP)

(21) Appl. No.: 13/561,715

(22) Filed: Jul. 30, 2012

(30) Foreign Application Priority Data
Aug. 4, 2011 (JP) 2011-170799

(51) Int. Cl. G03G 15/20

(52) U.S. Cl. 399/67; 399/329

(57) ABSTRACT

An image heating apparatus includes a coil; a heating member; magnetic cores arranged in a widthwise direction of the heating member; a moving mechanism; and a controller. The controller controls, depending on a recording material size, the moving mechanism so that the cores located outside the cores in a set range with respect to the widthwise direction are moved away from the heating member. When the recording material of a size is conveyed to the image heating apparatus, the controller controls the moving mechanism so that the cores, of the cores in the set range, located outside a recording material passing range with respect to the widthwise direction are only the cores located at end portions of the set range with respect to the widthwise direction.

### FIELD OF THE INVENTION AND RELATED ART

The present invention relates to an image heating apparatus to be mounted in an image forming apparatus, such as a copying machine, a printer or a facsimile machine, for forming an image on a recording material. Particularly, the present invention relates to an image heating apparatus for heating the image by an image heating member of an induction heating type.

From the viewpoint of energy saving, as a heating type of the image heating apparatus, the induction heating type in which magnetic flux generated by a coil is caused to act on a heating member to carry an eddy current through the heating member, thereby to heat the heating member is employed (Japanese Laid-Open Patent Application (JP-A) 2001-194940 and JP-A 2011-53597).

In this induction heating type, in order to increase the magnetic flux acting on the heating member, disposition of magnetic cores so that a magnetic circuit for guiding the magnetic flux to the heating member is formed is effective.

However, in a constitution of JP-A 2001-194940, there is a possibility that a temperature of a non-sheet-passing region where the recording material does not pass through the image heating apparatus is excessively increased.

Therefore, in a constitution of JP-A 2011-53597, the plurality of magnetic cores are provided and arranged with respect to a widthwise direction of the heating member. In addition, a part of the magnetic cores is configured so that the part of magnetic cores can be retracted from a position for permitting the formation of the magnetic circuit for guiding the magnetic flux to the member. Further, in order to suppress the excessive transfer at the non-sheet-passing region, the magnetic cores are disposed, in a recording material passing region, at the position for permitting the formation of the magnetic circuit for guiding the magnetic flux to the heating member and are retracted, in the non-sheet-passing region, from the position for permitting the formation of the magnetic circuit for guiding the magnetic flux to the heating member.

However, also the magnetic core disposed immediately outside an edge of the recording material is retracted from the position for permitting the formation of the magnetic circuit for guiding the magnetic flux to the heating member. For that reason, there is a possibility that improper heating occurs in the neighborhood of an end portion of the recording material.

### SUMMARY OF THE INVENTION

A principal object of the present invention is to provide, in order to suppress excessive transfer at a non-sheet-passing region through which a recording material does not pass, an image heating apparatus capable of suppressing an occurrence of improper heating in the neighborhood of an end portion of the recording material even when a magnetic core is retracted.

According to an aspect of the present invention, there is provide an image heating apparatus comprising: a coil; a heating member for heating a toner image on a recording material by generating heat by magnetic flux generated from the coil; a plurality of magnetic cores provided and arranged in a widthwise direction of the heating member; a moving mechanism for moving at least a part of the plurality of magnetic cores so that a gap between the magnetic cores and the heating member is changed; and a control unit for controlling the moving mechanism, wherein the control unit controls, depending on a size of the recording material, the moving mechanism so that the magnetic cores located outside the magnetic cores in a set range with respect to the widthwise direction are moved away from the heating member, wherein when the recording material of a size is conveyed to the image heating apparatus, the control unit controls the moving mechanism so that the magnetic cores, of the magnetic cores in the set range, located outside a recording material passing range with respect to the widthwise direction are only the magnetic cores located at end portions of the set range with respect to the widthwise direction.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is an illustration of a structure of an image forming apparatus.

FIG. 2 is an illustration of a structure of a principal portion of a fixing device (image heating apparatus).

FIG. 3 is a longitudinal sectional vie of the fixing device as seen from a secondary transfer portion side.

FIG. 4 is an illustration of a layer structure of a fixing belt.

Parts (a) and (b) of FIG. 5 are illustrations of movement of magnetic cores.

FIG. 6 is an illustration of a moving mechanism of the magnetic cores.

FIG. 7 is a perspective view of the fixing device.

FIG. 8 is an illustration of arrangement of the magnetic cores.

FIG. 9 is an illustration of positioning of the magnetic cores at a non-sheet-passing portion.

FIG. 10 is an illustration of a temperature distribution at the time of print start.

FIG. 11 is a flow chart of non-sheet-passing portion heating control in Embodiment 1.

FIG. 12 is an illustration of non-sheet-passing portion temperature rise after the print start.

### DESCRIPTION OF THE PREFERRED EMBODIMENTS

Hereinbelow, embodiments of the present invention will be described in detail with reference to the drawings. The present invention can be carried out also in other embodiments in which a part or all of constitutions of the respective embodiments are replaced by their alternative constitutions so long as outside magnetic cores located outside a sheet passing region are positioned equally to magnetic cores located inside the sheet passing region.

Therefore, an image heating apparatus includes not only a fixing device for fixing a toner image on a recording material by heating the recording material on which the toner image is transferred but also an image heating apparatus for providing a desired surface property to an image by heating a toner image which is partly fixed or completely fixed. A single image heating apparatus which is not only mounted in an image forming apparatus but also improves glossiness of an image by re-heating the image fixed on the recording material is also included. An image heating member and a pressing member may be any combination of belt and roller members.

An image forming apparatus can mount the image heating apparatus of the present invention irrespective of the types of monochromatic/full-color, sheet-feeding/recording material conveyance/intermediary transfer, a toner image forming method and a transfer method.

In the following embodiments, only a principal portion concerning formation/transfer/fixing of the toner image will be described but the present invention can be carried out in image forming apparatuses with various uses including printers, various printing machines, copying machines, facsimile machines, multi-function machines, and so on by adding necessary equipment, options, or casing structures.

### <Image Forming Apparatus>

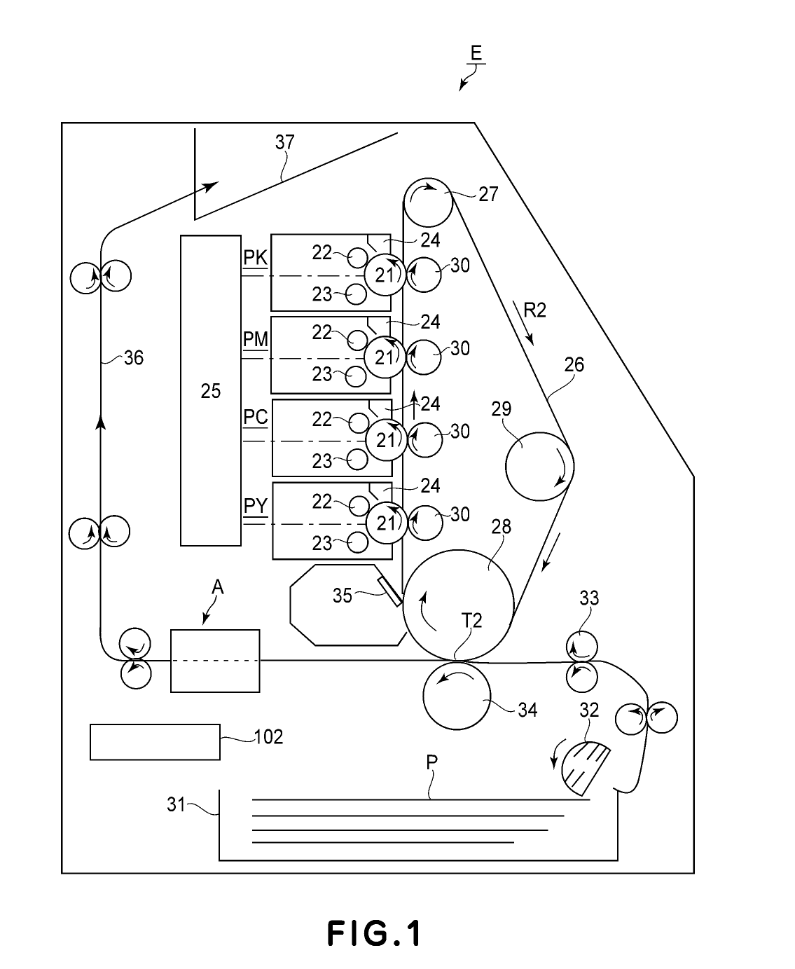

FIG. 1 is an illustration of structure of an image forming apparatus.

As shown in FIG. 1, an image forming apparatus E in this embodiment is a tandem-type full-color printer of an intermediary transfer type in which image forming portions PY, PC, PM and PK for yellow, cyan, magenta and black, respectively, are arranged along an intermediary transfer belt 26.

In the image forming portion PY, a yellow toner image is formed on a photosensitive drum 21(Y) and then is transferred onto the intermediary transfer belt 26. In the image forming portion PC, a cyan toner image is formed on a photosensitive drum 21(C) and is transferred onto the intermediary transfer belt 26. In the image forming portions PM and PK, a magenta toner image and a black toner image are formed on photosensitive drums 21(M) and 21(K), respectively, and are transferred onto the intermediary transfer belt 26.

The intermediary transfer belt 26 is stretched around a driving roller 27, a secondary transfer opposite roller 28 and a tension roller 26, and is driven by the driving roller 26.

A recording material P is pulled out from a recording material cassette 31 one by one by a sheet feeding roller 32 and is in stand-by between registration rollers 33.

The recording material P is sent by the registration rollers 33 to a secondary transfer portion T2 where in a process in which the recording material P is nip-conveyed while being superposed on the toner image, the toner images are transferred from the intermediary transfer belt 26 onto the recording material P. The recording material P on which the four color toner images are transferred is conveyed into a fixing device A is, after being heated and pressed by the fixing device A to fix the toner images thereon, discharged onto an external tray 36 via a discharge conveying path 36.

The image forming portions PY, PC, PM and PK have the substantially same constitution except that the colors of toners of yellow, cyan, magenta and black used in developing devices 23(Y), 23(C), 23(M) and 23(K) are different from each other. In the following description, the image forming portion PY will be described and other image forming portions PC, PM and PK will be omitted from redundant description.

The image forming portion PY includes the photosensitive drum 21 around which a charging roller 22, an exposure device 25, the developing device 23, a transfer roller 30, and a drum cleaning device 24 are disposed.

The charging roller 22 electrically charges the surface of the photosensitive drum 21 to a uniform potential. The exposure device 25 writes (forms) an electrostatic image for an image on the photosensitive drum 21 by scanning with a laser beam. The developing device 23 develops the electrostatic image to form the toner image on the photosensitive drum 21. The transfer roller 30 is supplied with a DC voltage, so that the toner image on the photosensitive drum 21 is transferred onto the intermediary transfer belt 26.

### <Fixing Device>

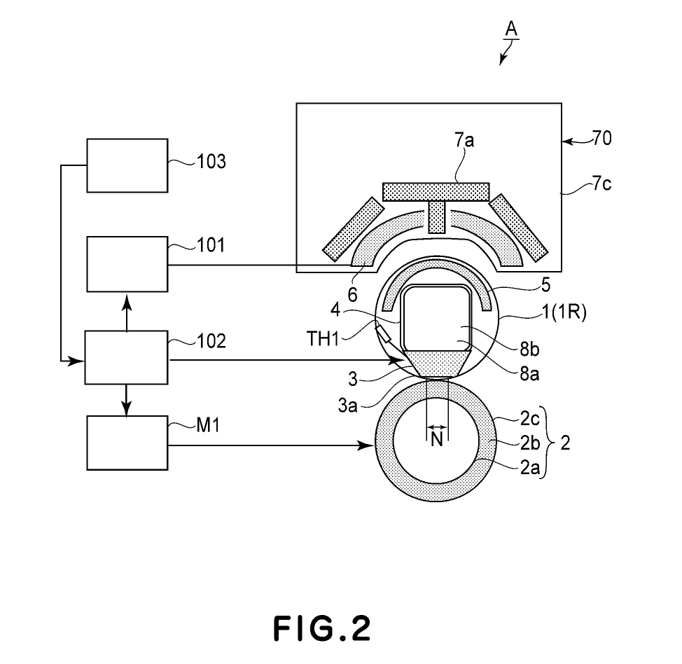

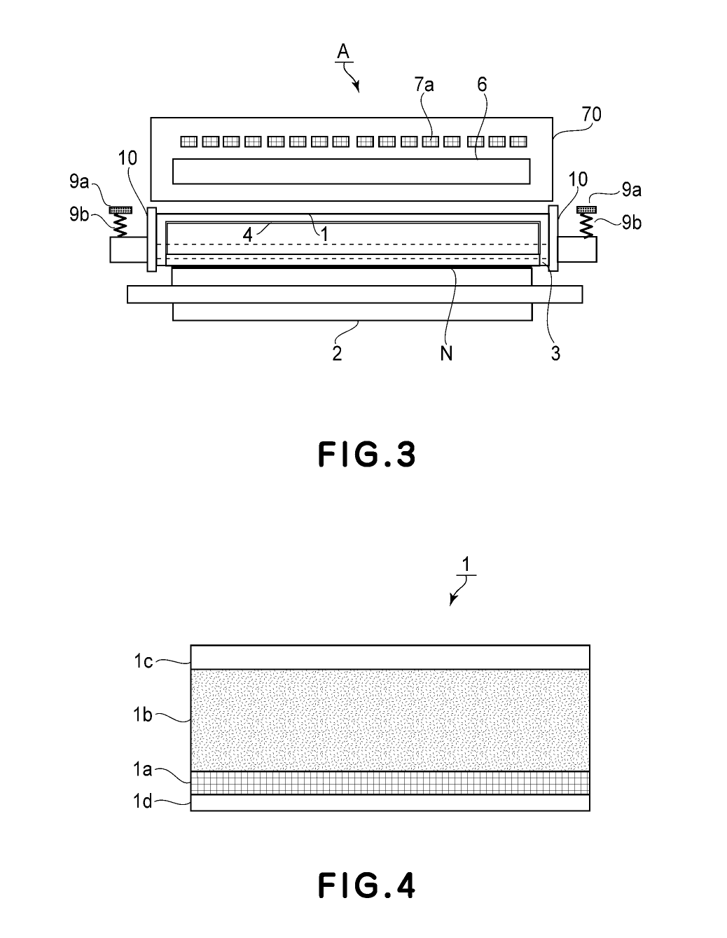

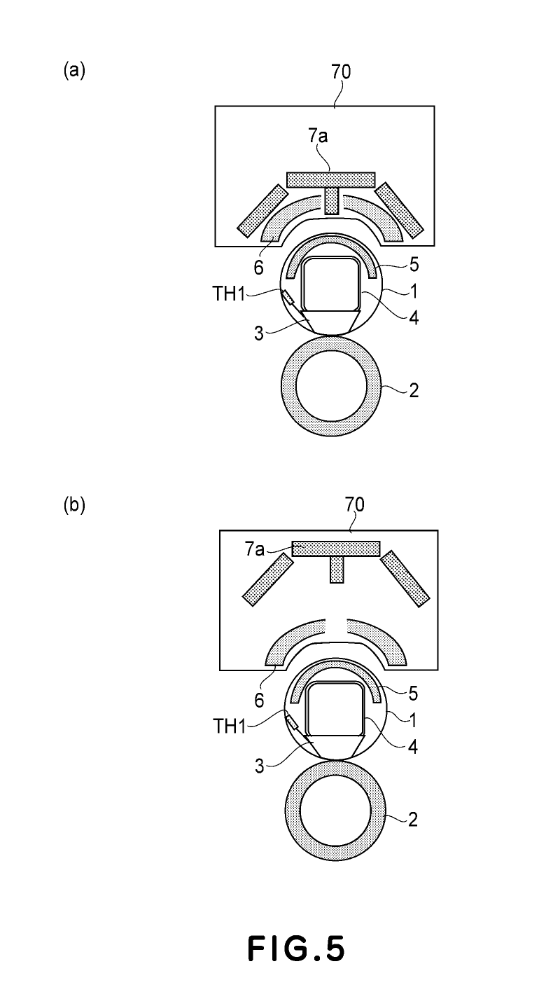

FIG. 2 is an illustration of a structure of a principal portion of the fixing device. FIG. 3 is a longitudinal sectional view of the fixing device as seen from the secondary transfer portion side. FIG. 4 is an illustration of a layer structure of a fixing belt 1. In the following description, with respect to the fixing device, a front surface refers to a surface as seen from a recording material entrance side, and a rear surface is a surface, as seen from a recording material exit side, opposite from the front surface. The left (side) and the right (side) of the fixing device refer to left (side) and right (side) as seen from the front surface side. An upstream side and a downstream side refer to an upstream side and a downstream side with respect to a recording material conveyance direction.

As shown in FIG. 2, the fixing belt 1 is rotationally driven, by rotationally driving the pressing roller 2 by a motor M1 controlled by a controller 102, at the substantially same peripheral speed as a conveyance speed of the recording material P conveyed from the secondary transfer portion T2 in FIG. 1. The fixing device A is capable of continuously fixing sheets of the recording material P at a surface rotational speed of 300 mm/sec, thus fixing a full-color image on the recording material at 80 sheets/min for A4-size landscape feeding and at 58 sheets/min for A4-size portrait feeding.

The recording material P on which an unfixed toner image is carried is guided by a guide member 7 with its toner image carrying surface toward the fixing belt 1, thus being introduced into a heating nip N press-formed by the fixing belt 1 and a pressing roller 2.

The recording material P is closely contacted to the outer peripheral surface of the fixing belt 1 in the heating nip N and is nip-conveyed in the heating nip N together with the fixing belt 1.

The unfixed toner image T is supplied with the pressure under application of heat in the heating nip N, thus being fixed on the surface of the recording material P. The recording material P having passed through the heating nip N is self-separated from the outer peripheral surface of the fixing belt 1 since the surface of the fixing belt 1 is deformed at an exit portion of the heating nip N, and then is conveyed to the outside of the fixing device A.

The fixing belt 1 is an endless belt having a metal layer and resin layer. The fixing belt 1 is the endless belt of 30 mm in inner diameter and is induction-heated by an induction heating device 70, and is rotated in contact to the recording material. The pressing roller 2 is press-contacted to the fixing belt 1 to form the heating nip N for the recording material.

The pressing roller 2 is prepared by providing an almost 5 mm-thick elastic layer 2b of a silicone rubber on a core metal 2a of iron alloy which is 20 mm in diameter at a longitudinal central portion and is 19 mm in diameter at each of end portions. On a surface of the elastic layer 2b, a parting layer 2c of fluorine-containing resin (such as PFA or PTFE) is provided in a thickness of 30 μm. The pressing roller 2 has a hardness (Asker-C hardness) of 70 degrees. The reason why the core metal 2a has a tapered shape is that even when a pressure-applying member 3 is bent under pressure application, pressure in the heating nip N between the fixing belt 1 and the pressing roller 2 can be uniformly ensured with respect to a longitudinal direction.

The core metal 2a is tapered, so that the thickness of the elastic layer 2b is different between the central portion and each of the end portions. For this reason, a length of the heating nip N between the fixing belt 1 and the pressing roller 2 is, when the fixing nip pressure is 600 N, about 9 mm at each of the longitudinal end portions and about 8.5 mm at the longitudinal central portion. As a result, a conveying speed of the recording material P at each of the end portions is higher than that at the central portion, so that there is such an advantage that paper creases are not readily generated.

The pressure-applying member 3 is held by a metal stay 4 at its inner surface and supports an inner surface of the fixing belt 1 by its outer surface. The pressure-applying member 3 applies an urging force (pressure) to the pressing roller 2 via the fixing belt 1, thus forming the heating nip N between the fixing belt 1 and the pressing roller 2. The pressure-applying member 3 is formed of a heat-resistant resin material. In a side where the stay 4 opposes an exciting coil 6, a magnetic flux shielding core 5 as a magnetic flux shielding member for preventing temperature rise of the stay 4 caused due to induction heating is provided.

As shown in FIG. 3, the stay 4 is required to have rigidity in order to apply pressure to the press-contact portion between the fixing belt 1 and the pressing roller 2 and therefore is formed of metal. The stay 4 is close to the exciting coil 6 particularly at end portions and in order to shield a magnetic field generated by the exciting coil 6 so as to prevent heat generation of the stay 4, the magnetic flux shielding core 5 is disposed over the upper surface of the stay 4 with respect to the longitudinal direction.

Each of fixing flanges 10 which is an example of a pair of guide members is provided non-rotatably at end portions of the endless belt and includes an outer peripheral portion for supporting an inner peripheral surface of the endless belt and a flange portion abutted against the edge of the endless belt. The fixing flanges 10 are left and right preventing members (regulating members) for preventing (regulating) longitudinal movement of and circumferential shape of the fixing belt 1 are provided. A stay urging spring 9b is compressedly provided between each end portion of the stay 4 provided by being inserted into the flanges 10 and a spring receiving portion 9a provided in a device chassis side, so that a pressing-down force is applied to the stay 4. As a result, the lower surface of the pressure applying member 3 and the upper surface of the pressing roller 2 are press-contacted to the fixing belt 1 therebetween, so that the hating nip N for the image on the recording material is formed. A base layer of the fixing belt 1 is formed of metal and therefore even in the rotation state, as a means for preventing deviation (shift) in a widthwise direction, provision of the fixing flanges only for simply receiving the end portions of the fixing belt 1 suffice. As a result, there is the advantage such that the constitution of the fixing device can be simplified.

As shown in FIG. 4, the fixing belt 1 includes a 40 μm-thick base layer (metal layer) la of nickel which is manufactured through electroforming.

As a material for the base layer 1a, in addition to nickel, an iron alloy, copper, silver or the like is appropriately selectable. Further, the base layer 1a may also be constituted so that a layer of the metal or metal alloy described above is laminated on a resin material base layer. The thickness of the base layer 1a may be adjusted depending on a frequency of a high-frequency current caused to flow through the exciting coil described later and depending on magnetic permeability and electrical conductivity of the base layer and may be set in a range from 5 μm to 200 μm.

On the other peripheral surface of the base layer 1a, an elastic layer 1b which is a heat-resistant silicone rubber layer is provided. The thickness of the elastic layer 1b may preferably be set within a range of 100-1000 μm. In this embodiment, in consideration of reduction in a warming-up time by decreasing thermal capacity of the fixing belt 1 and obtaining of a suitable fixed image when the color images are fixed, the thickness of the elastic layer 1b is 300 μm. The silicone rubber layer as the elastic layer 1b has a hardness (JIS-A) of 20 degrees and is 0.8 W/mK in thermal conductivity. On the other peripheral surface of the elastic layer 1b, a parting layer 1c of fluorine-containing resin (such as PFA or PTFE) is formed in a thickness of 30 μm. On the inner surface of the base layer 1a, in order to lower sliding friction between the fixing belt inner surface and a central thermistor (TH1 in FIG. 2), a lubricating layer 1d of fluorine-containing resin or polyimide is formed in a thickness of 10-50 μm. In this embodiment, a 20 μm-thick polyimide layer was provided as the lubricating layer 1d.

### <Induction Heating Device>

As shown in FIG. 2, the induction heating device 70 is a heating source for induction-heating the fixing belt 1. The induction heating device 70 is disposed opposed to the fixing belt 1 with a predetermined gap (spacing) in an upper peripheral surface side of the fixing belt 1. The fixing belt 1 which is an example of a rotatable image heating member generates heat by magnetic flux generated from the exciting coil 6 which is an example of a coil, thus heating the image on the recording material.

The exciting coil 6 uses Litz wire as an electric wire and is prepared by winding Litz wire in an elongated ship's bottom-like shape so that the exciting coil 6 opposes a part of the peripheral surface of the fixing belt 1. The exciting coil 6 is 352 mm in inner diameter and 392 mm in outer diameter with respect to the longitudinal direction. In the rotation state of the fixing belt 1, to the exciting coil 6, a high-frequency current of 20-50 Hz is applied from a power supply device (exciting circuit) 101, so that the metal layer (electroconductive layer) of the fixing belt 1 is induction-heated by the magnetic field generated by the exciting coil.

Magnetic cores 7a are provided so as to cover the exciting coil 6 so that the magnetic field generated by the exciting core 6 is not substantially leaked to a portion other than the metal layer (electroconductive layer) of the fixing belt 1. The magnetic cores 7a have the function of efficiently guiding AC magnetic flux generated from the exciting coil 6 to the fixing belt 1. The magnetic cores 7a are used for increasing an efficiency of a magnetic circuit of the AC magnetic flux and for shielding the magnetic flux so as to avoid induction heating of peripheral members caused by leakage of the magnetic flux to the peripheral members. As a material for the magnetic cores 7a, a material such as ferrite having high permeability and low residual magnetic flux density.

A mold member 7c supports the exciting coil 6 and the magnetic cores 7a by an electrically insulating resin material. The fixing belt 1 and the magnetic cores 7a are kept in an electrically insulating state by the mold member 7c having a thickness of 0.5 mm. A spacing between the fixing belt 1 and the exciting coil 6 is constant at 1.5 mm (i.e., a distance between the mold surface and the fixing belt surface is 1.0 mm).

The central thermistor TH1 is a temperature sensor (temperature detecting element) and is provided at a widthwise central portion of the fixing belt 1 in contact to the fixing belt 1. The central thermistor TH1 is mounted to the pressure applying member 3 via an elastic supporting member and therefore even when positional fluctuation such as waving of a contact surface of the fixing belt 1 is generated, the central thermistor TH1 follows the positional fluctuation and is kept in a good contact state to the fixing belt 1. The central thermistor TH1 detects the temperature of the inner surface of the fixing belt 1 substantially at a center of a recording material conveying region, so that detected temperature information is fed back to the controller 102.

The power supply device 101 which is an example of an output controller controls electric power supplied to the exciting coil 6 so as to keep a sheet passing portion temperature of the fixing belt 1 at a predetermined temperature. The controller 102 controls the electric power supplied from the power supply device 101 to the exciting coil 6 so that the detected temperature inputted from the central thermistor TH1 is kept at a predetermined target temperature (fixing temperature). The controller 102 interrupts energization to the exciting coil 6 in the case where the detected temperature of the fixing belt 1 is increased up to the predetermined temperature.

The controller 102 changes, on the basis of a detected value of the central thermistor TH1, the frequency of the high-frequency current so that the detected temperature of the fixing belt 1 is constant at 180° C. as the target temperature of the fixing belt 1, thus controlling the electric power inputted into the exciting coil 6 to adjust the temperature. The exciting coil 6 of the induction heating device 70 connected to the power supply device 101 is controlled by the controller 102, so that the fixing belt 1 is heated to the predetermined fixing temperature. The controller 102 controls the electric power inputted into the exciting coil 6 by changing, on the basis of the detected value of the central thermistor TH1, the frequency of the high-frequency current so that the fixing belt temperature is kept at 180° C. as the target temperature of the fixing belt 1.

The induction heating device 70 including the exciting coil 6 is not disposed inside the fixing belt 1 which becomes a high temperature but is disposed inside the fixing belt 1 and therefore the temperature of the exciting coil 6 is not readily increased to the high temperature. Further, also an electric resistance is not increased, so that even when the high-frequency current is carried, it becomes possible to alleviate loss caused by Joule heat generation. Further, by externally disposing the exciting coil 6, the fixing belt 1 is downsized (low thermal capacity), so that it can be said that the induction heating device 70 is excellent in an energy saving property.

With respect to the warming-up time of the fixing device A, a constitution in which the thermal capacity is very low is employed and therefore when, e.g., 1200 W is inputted into the exciting coil 6, the temperature of the fixing device A can reach 165° C. as the target temperature in about 15 sec. There is no need to perform a heating operation during stand-by and therefore electric power consumption can be suppressed at a very low level.

Incidentally, in order to enable high-speed temperature rise during actuation of the fixing device, fixing devices such as a fixing device in which a fixing roller is formed in a small thickness and is downsized, a fixing device in which a fixing belt is internally heated by a heater, and a fixing device in which a thin metal fixing belt is induction-heated have been conventionally proposed.

Also from the viewpoints of material cost and energy efficiency, in the image forming apparatus E, it is a desirably tendency that the thermal capacity is decreased by using a thin image heating member and the fixing belt is heated by the induction heating device with a good heating efficiency.

However, in the case where the thin image heating member is used, a cross-sectional area of a cross section perpendicular to the widthwise direction is very small and therefore a heat transfer efficiency with respect to the widthwise direction is not good. This tendency is conspicuous with a smaller thickness of the image heating member, and is further low for a resin material with a low thermal conductivity.

This is also clear from the Fourier's law such that a heat quantity Q transmitted per unit time is, when the thermal conductivity is λ, a temperature difference between two point is θ1−θ2 and a length between the two points is L, represented by the following formula:

Q=λ×f(θ1−θ2)/L.

This is not so problematic in the case where the recording material has a width corresponding to a full length of the image heating member with respect to the widthwise direction, i.e., in the case where the recording material with a maximum sheet passing width is subjected to continuous sheet passing and fixing. However, in the case where a small-sized recording material with a small length with respect to the widthwise direction is subjected to the continuous sheet passing, a so-called non-sheet-passing portion transfer such that temperature non-uniformity is generated at the end portions of the image heating member with respect to the widthwise direction occurs. In a state in which heat transfer of the image heating member with respect to the widthwise direction is not good, when the small-sized recording material is subjected to the continuous sheet passing, the temperature of the image heating member at the non-sheet-passing portion is increased move than at the sheet passing portion, so that the temperature of the image heating member at the non-sheet-passing portion becomes higher than the control temperature and thus the non-sheet-passing portion transfer is generated.

When this non-sheet-passing portion temperature rise is left standing, a temperature difference between the sheet passing portion and the non-sheet-passing portion becomes large and thus there is a possibility that paper crease due to partial temperature non-uniformity in the heating nip N can occur when a large-sized recording material is subjected to sheet passing immediately after the continuous sheet passing of the small-sized recording material. There is a possibility that fixing non-uniformity can occur due to recording material heating non-uniformity. There is a possibility that a durable lifetime of members of a resin material disposed at a periphery of the non-sheet-passing portion is lowered. The temperature difference between the sheet passing portion and the non-sheet passing portion is enlarged with a larger thermal capacity of the recording material to be conveyed and with a higher throughput (print (image formation) number per unit time). For this reason, with respect to the fixing device using the thin fixing belt with low thermal capacity, it was difficult to mount the fixing device in a copying machine with the high throughput. In the copying machine with high productivity, in many cases, the non-sheet-passing portion transfer was avoided by dividing a halogen lamp heater or a heat generating resistor into a plurality of portions and then by heating a region depending on the recording material size.

Also in the fixing device using an induction coil as the heating source, it is possible to effect selective energization by similarly dividing the heating source into the plurality of portions. However, the fixing device using the thin fixing belt with the low thermal capacity is, in the case where the induction heating device is divided and provided in the plurality of portions, complicated with respect to a control circuit and is increase in cost. In the case of the thin fixing belt with the low thermal capacity, a temperature distribution is discontinuous in the neighborhood of boundaries of divided heating regions, so that the fixing belt cannot satisfy a necessary temperature uniformity.

Therefore, in the fixing device A, between the fixing belt 1 and the exciting coil 6, the magnetic cores 7a capable of setting, a region, every 10 mm in width, of the magnetic flux guided from the exciting coil 6 to the fixing belt 1 are disposed. In order to meet various sizes of the recording material, the divided magnetic cores 7a are disposed with respect to the widthwise direction of the fixing belt 1.

As shown in FIG. 3, the divided magnetic cores 7a extend in the longitudinal direction (widthwise direction) of the fixing belt 1 and are disposed so that each magnetic core has a width of 10 mm and adjacent magnetic cores are disposed with an interval (spacing) of 1.0 mm. Then, by moving downward the magnetic cores 7a in a number corresponding to a conveying widthwise size of the recording material, a degree of the magnetic flux sent from the induction heating device 70 in a region other than a region necessary to be heated is decreased, so that the heat generation of the fixing belt 1 itself is suppressed. As a result, control of the heating region is effected, so that it becomes possible to precisely control the temperature distribution of the fixing belt 1 to be increased in temperature. Even at a position close to the widthwise center of the fixing belt in the non-sheet-passing region, the distance between the exciting coil 6 and the magnetic cores 7a is sufficiently ensured, so that it is possible to avoid the non-sheet-passing portion temperature rise.

### <Magnetic Core Moving Mechanism>

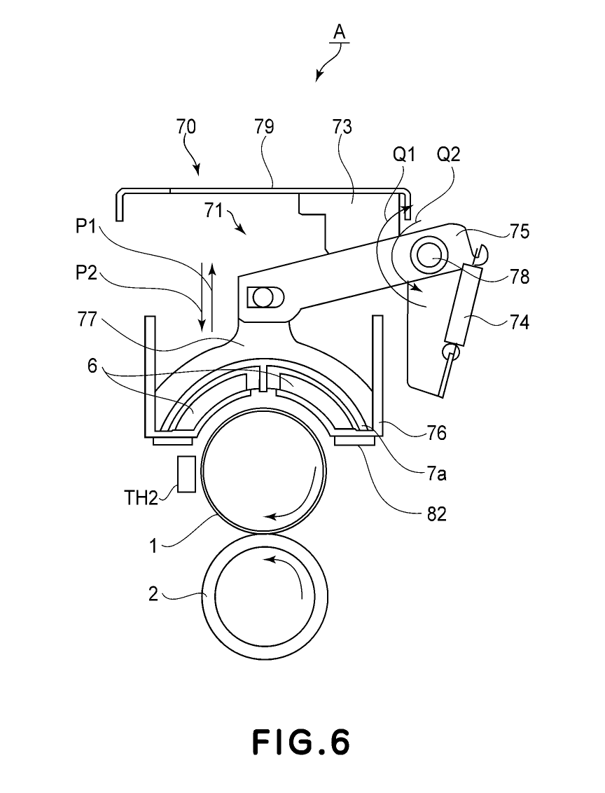

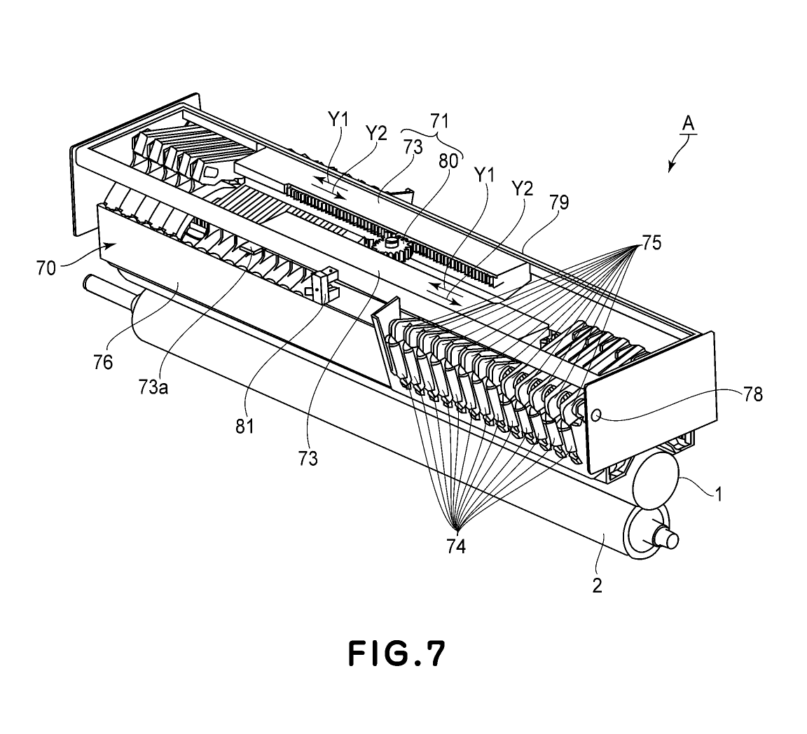

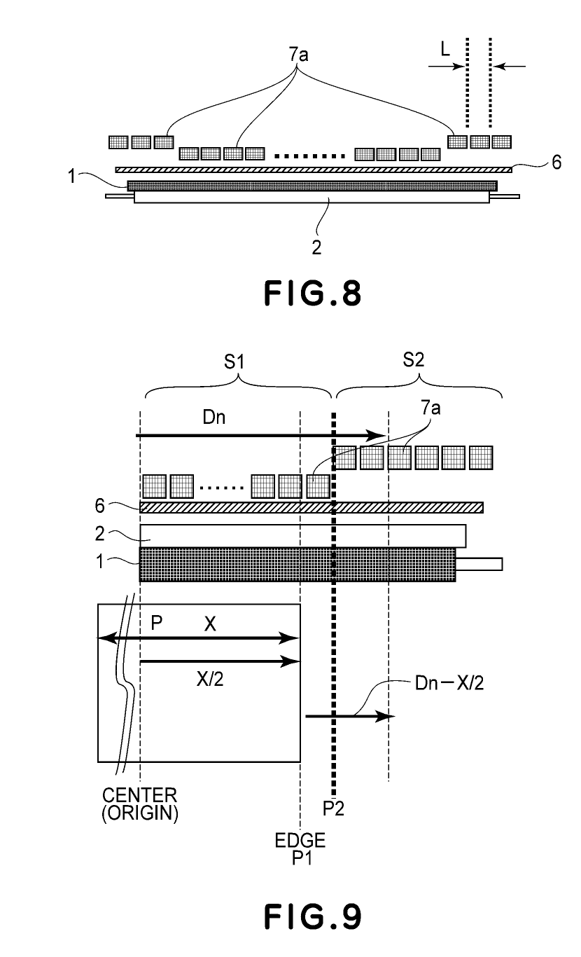

Parts (a) and (b) of FIG. 5 are illustrations of movement of magnetic cores. FIG. 6 is an illustrations of a moving mechanism of the magnetic cores. FIG. 7 is a perspective view of the fixing device. FIG. 8 is an illustration of arrangement of the magnetic cores.

As shown in (a) of FIG. 5, at the sheet passing portion, by narrowing the gap between the exciting coil 6 and the magnetic cores 7a, a density of the magnetic flux passing through the fixing belt 1 is increased, so that an amount of heat generation of the fixing belt 1 is increased. That is, with respect to the widthwise direction, the magnetic cores in a set range are disposed close to the fixing belt 1, and the magnetic cores located outside the set range are moved away from the fixing belt 1 more than those in the set range. Further, in this embodiment, in order to suppress a lowering in glossiness of the image formed close to an edge of the recording material, the set range is set depending on the recording material size in the following manner. That is, with respect to the widthwise direction, the set range is set so that it is longer in set distance than a recording material passing range and so that its widthwise ends are located outside corresponding edges of the recording material passing range.

In the sheet passing portion, the gap between the exciting coil 6 and the magnetic cores 7a is 0.5 mm (first distance). That is, the magnetic cores are disposed at a magnetic flux including position for permitting induction of the magnetic flux generated by the coil to the fixing belt 1.

As shown in (b) of FIG. 5, at the non-sheet-passing portion, by increasing the gap between the exciting coil 6 and the magnetic cores 7a, the density of the magnetic flux passing through the fixing belt 1 is decreased, so that an amount of heat generation of the fixing belt 1 is decreased.

In the non-sheet-passing portion, the gap between the exciting coil 6 and the magnetic cores 7a is increased to 10 mm (second distance). That is, the magnetic cores are disposed at a retracted position where the magnetic cores are retracted so that the magnetic flux generated by the coil is prevented from acting on the fixing belt 1. That is, the magnetic cores 7a is movable from the position where the distance from the exciting coil 6 is the first distance to the position where the distance from the exciting coil 6 is the second distance which is larger than the first distance.

As shown in FIG. 6, a core moving mechanism 71 changes a vertical movement distance of the magnetic cores 7a depending on the size of the recording material. The core moving mechanism 71 which is an example of a moving means moves the plurality of magnetic cores 7a disposed opposed to the fixing belt 1, so that the magnetic cores 7a can be disposed at the magnetic flux inducing position where the magnetic cores 7a are close to the fixing belt 1 and at the retracted position where the magnetic cores 7a are remote from the fixing belt 1.

The magnetic cores 7a are accommodated in a housing 76 while being held by a magnetic core holder 77. The magnetic core holder 77 is movable in a direction in which the gap between the exciting coil 6 and the magnetic cores 7a is changed. A link member 75 is assembled rotatably about a rotation shaft 76 and is connected to the magnetic core holder 77 at an elongated hole portion provided at its end portion. When the link member 75 is rotated about the rotation shaft 78 in Q1 direction, the magnetic core holder 77 and the magnetic cores 7a are moved in P1 direction. When the link member 75 is rotated about the rotation shaft 78 in Q2 direction, the magnetic core holder 77 and the magnetic cores 7a are moved in P2 direction.

The link member 75 is surged by an exciting coil spring 74 in a direction in which it is rotated in the Q1 direction, but is prevented from moving in the Q1 direction by a regulating (preventing) member 73.

In a state in which the link member 75 is pressed-in by the regulating member 73, the link member 75 is rotationally moved in the Q2 direction against the exciting coil spring 74. At this time, the magnetic core holder 77 is moved in the arrow P2 direction, so that the magnetic cores 7a approach the exciting coil 6.

When the pressing-in of the link member 75 by the regulating member 73 is released (eliminated), the link member 75 is rotationally moved in the Q1 direction by being urged by the exciting coil spring 74 and thus is abutted against a frame 79 to be stopped. As a result, the magnetic core holder 77 is moved in the arrow P1 direction, so that the magnetic cores 7a are moved away from the exciting coil 6.

As shown in FIG. 7, the regulating member 73 is connected to a central pinion gear 80 and is movable in widthwise directions (Y1 and Y2 directions) perpendicular to the recording material conveyance direction by rotational motion of the pinion gear 80. When the regulating member 73 is moved in the Y1 direction, the pressing-in by the regulating member 73 successively released from an end portion-side link member 75, so that the magnetic cores 7a are moved away from the exciting coil 6 successively from an end portion side toward a central portion side. In FIG. 7, with respect to four magnetic cores 7a from the end portion side, the pressing-in by the regulating member 73 is released, so that the gap between the exciting coil 6 and the magnetic cores 7a is increased.

As shown in FIG. 6, the controller 102 (control unit) controls the core moving mechanism 71 to release the pressing-in by the regulating member 73 with respect to a predetermined number of the magnetic cores 7a in the magnetic core holder 77 determined depending on a conveyance widthwise direction of the recording material. As a result, the gap between the exciting coil 6 and the magnetic cores 7a located outside the recording material is increased, so that the non-sheet-passing portion transfer is prevented. In order to meet various recording material sizes such as postcard size, A5 size, B4 size, A3 size and A3 plus size, the position of the regulating member 73d is changed depending on the recording material size, so that a heating region depending on each recording material size is set and thus the non-sheet-passing portion transfer is suppressed.

In recent years, the types of the sizes of the recording material are increased, even with respect to the respective sizes, the fixing device has been required to avoid the non-sheet-passing portion transfer without lowering the throughput. However, as shown in FIG. 8, even in the case where many magnetic cores 7a are used, depending on the recording material size, uneven glossiness can occur on the edge of the recording material. In the following embodiments, in the fixing device using the fixing belt with the low thermal capacity, even when many types of the recording material sizes are used, a fixing quality is ensured until the edge of the recording material while avoiding the non-sheet-passing portion transfer sufficiently.

### Embodiment 1

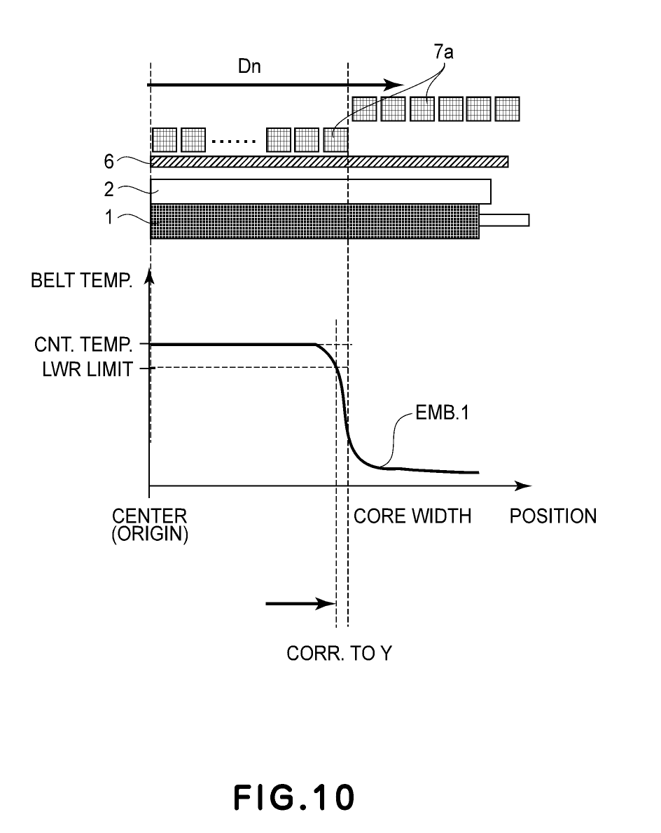

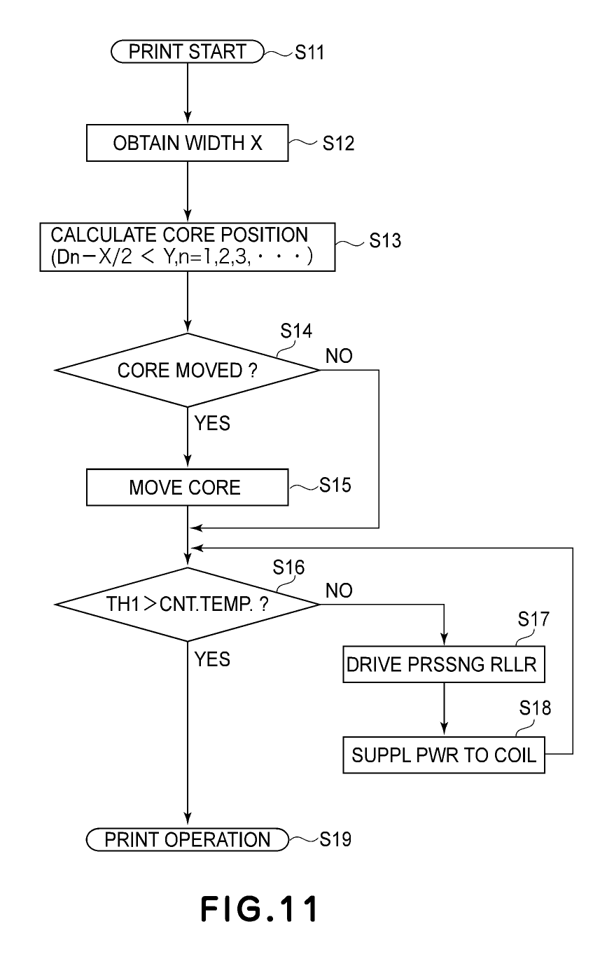

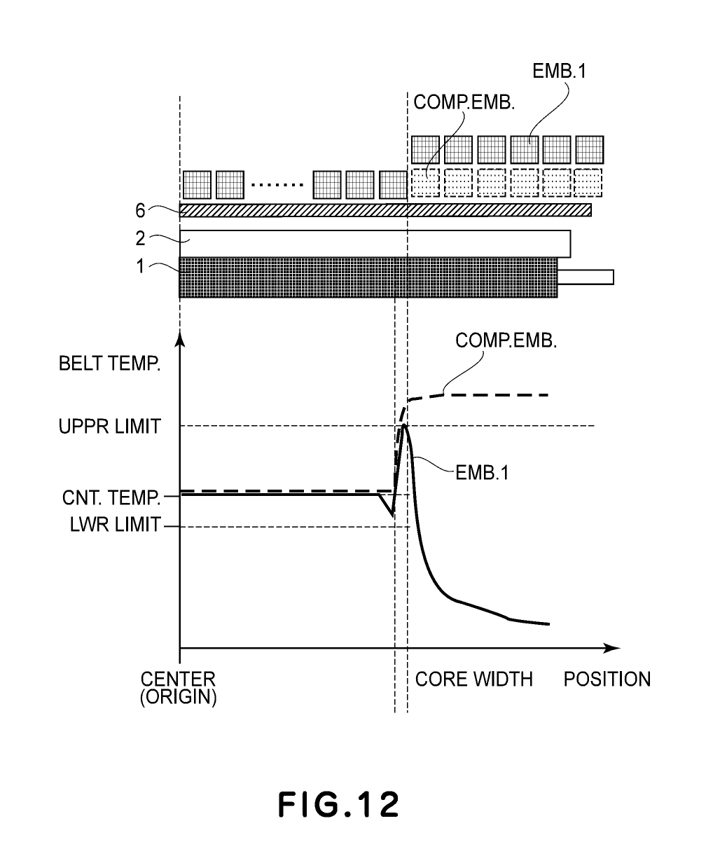

FIG. 9 is an illustration of positioning of magnetic cores at a non-sheet-passing portion. FIG. 10 is an illustration of a temperature distribution of a fixing belt during print start. FIG. 11 is a flow chart of non-sheet-passing portion heating control in Embodiment 1. FIG. 12 is an illustration non-sheet-passing portion transfer after the print start.

As shown in FIG. 2, in this embodiment, when a print job is received in a sleep state or a stand-by state in which the temperature is lowered, heat generation control of the fixing belt 1 during pre-rotation is executed to actuate the fixing device. The pre-rotation is started by making setting of a heat generation width using the magnetic cores 7a. The controller 102 which is an example of a determining means obtains, on the basis of setting through an operating portion 103 which is an example of detecting means for detecting the size of the recording material, an end portion position of a sheet passing portion region with respect to the widthwise direction of the fixing belt 1. The controller 102 determines that the magnetic cores 7a located, in a non-sheet-passing portion region, inside a range set in advance from the end portion position of the sheet passing portion region toward the outside are disposed at a magnetic flux inducing position. The controller 102 determines that the magnetic cores 7a located, with respect to the widthwise direction, outside the magnetic cores 7a determined to be disposed at the magnetic flux inducing position are disposed at a retracted position.

As shown in FIG. 9, parameters are defined as follows by taking, as an origin, a center position of the sheet passing portion with respect to the widthwise direction of the fixing belt 1.

n: the number for identifying each of the magnetic cores 7a. In the case where the magnetic cores 7a are disposed in both sides of the origin, the magnetic cores 7a are numbered 1, 2, 3, . . . toward the outside. When the magnetic core 7a is disposed at the origin, the magnetic core 7a is numbered 0 and other magnetic cores 7a are numbered 1, 2, 3, . . . toward the outside.

Dn: a distance from the origin to n-th magnetic core. With respect to the widthwise direction, the distance from the magnetic core 7a located at the center of the sheet passing portion region to an outer edge of the n-th magnetic core 7a is Dn.

X: a recording material length with respect to the widthwise direction of the fixing belt 1. A distance from the origin to the edge is X/2.

Y: a distance in which the magnetic core 7a is required to be disposed outside the recording material with respect to the widthwise direction of the fixing belt 1 in order to ensure a fixable temperature width. The distance from a position of a lower limit of a sheet-passable temperature to the edge of the recording material when only the magnetic core 7a at least partly overlapping with the sheet passing portion region is disposed at the magnetic flux including position to heat the fixing belt 1 by the magnetic core 7a is Y.

As shown in FIG. 10, even when the heat generation range where the magnetic flux enters the fixing belt 1 in a large amount is limited by the magnetic cores 7a, a range in which the fixing belt 1 is increased in temperature up to the neighborhood of the target control temperature becomes narrower than the width of the magnetic cores 7a. This is principally because heat conduction in accordance with Fourier's law represented by an equation (1) shown below is generated with respect to the widthwise direction of the fixing belt 1 by a temperature difference generated between a region where the magnetic flux of the fixing belt 1 enters in a large amount and a region where the magnetic flux of the fixing belt 1 does not enter.

Q=λ·f(θ1−θ2)/L (1)

Therefore, in order to keep the temperature not less than a lower-limit fixing temperature so as to fix the toner image on the recording material with no inconvenience, a range in which the magnetic cores 7a are moved toward the exciting coil 6 is required to be made larger than a length X of the recording material with respect to the widthwise direction of the fixing belt 1. In this way, a distance extended to the outside is defined as Y. A value of Y is determined from not only a thermal conductivity λ but also a plurality of conditions such as λ of a member contacting the fixing belt 1 and a temperature difference between the heat generation range and a non-heat generation range and therefore it is difficult to theoretically obtain the value of Y. However, the value of Y can be empirically determined relatively easily when the width of the magnetic cores 7a moved toward the exciting coil 6 and the heat generation distribution of the fixing belt 1 are measured.

The controller 102 determines that the magnetic cores 7a satisfying the following relationship are disposed at the magnetic flux inducing position.

Dn−X/2<Y (2)

As an example of the fixing device A, during the pre-rotation, the fixing belt 1 is heated from a substantially room temperature state to 165° C. as the control temperature by applying the power of 1200 W to the exciting coil 6. At this time, when the lower-limit fixing temperature is determined as 160° C., in order to realize a widthwise length range of 300 mm in which the fixing belt 1 is heated to 160° C. or more, the length of the range in which the magnetic cores 7a are moved toward the exciting coil 6 was 316 mm. Therefore, in Embodiment 1, Y was determined as 8 mm.

Y=(316 mm−300 mm)/2

By repeating a similar experiment, with respected to the recording materials of various sizes, the length of the range in which the magnetic cores 7a are moved toward the exciting coil 6 was obtained.

TABLE 1

| | | Outside magnetic cores | | | | | |
|---|---|---|---|---|---|---|---|
| | | | | | | n = 9 | n = 10 |
| | Width | n = 0 | n = 1 | . . . | n = 8 | Dn = | Dn = |
| Size | (X) | — | Dn = 10.5 | . . . | Dn = 87.5 | 98.5 | 109.5 |
| B5R | 182 | — | (−80.5) | . . . | (−3.5) | (7.5) | 18.5 |
| A5, | 210 | — | (−94.5) | . . . | (−17.5) | (−6.5) | (4.5) |
| A4R | | | | | | | |
| LGL, | 215.9 | — | (−97.5) | . . . | (−20.5) | (−9.5) | (1.6) |
| LTR | | | | | | | |
| B5 | 257 | — | (−118.0) | . . . | (−41.0) | (−30.0) | (−19.0) |
| LDR, | 279.4 | — | (−129.2) | . . . | (−52.2) | (−41.2) | (−30.2) |
| LTRR | | | | | | | |
| A3, A4 | 297 | — | (−138.0) | . . . | (−61.0) | (−50.0) | (−39.0) |
| 13 | 330.2 | — | (−154.6) | . . . | (−77.6) | (−66.6) | (−55.6) |
| inch | | | | | | | |

| | | Outside magnetic cores | | | | | |
|---|---|---|---|---|---|---|---|
| | | | | | | | n = |
| | | n = 11 | n = 12 | n = 13 | n = 14 | n = 15 | 16 |
| | Width | Dn = | Dn = | Dn = | Dn = | Dn = | Dn = |
| Size | (X) | 120.5 | 131.5 | 142.5 | 153.5 | 164.5 | 175.5 |
| B5R | 182 | 29.5 | 40.5 | 51.5 | 62.5 | 73.5 | 84.5 |
| A5, | 210 | 15.5 | 26.5 | 37.5 | 48.5 | 59.5 | 70.5 |
| A4R | | | | | | | |
| LGL, | 215.9 | 12.6 | 23.6 | 34.6 | 45.6 | 56.6 | 67.6 |
| LTR | | | | | | | |
| B5 | 257 | (−8.0) | (3.0) | 14.0 | 25.0 | 36.0 | 47.0 |
| LDR, | 279.4 | (−19.2) | (−8.2) | (2.8) | 13.8 | 24.8 | 35.8 |
| LTRR | | | | | | | |
| A3, A4 | 297 | (−28.0) | (−17.0) | (−6.0) | (5.0) | 16.0 | 27.0 |
| 13 | 330.2 | (−44.6) | (−33.6) | (−22.6) | (−11.6) | (−0.6) | 10.4 |
| inch | | | | | | | |

In Table 1, respective values for n=0 to n=16 are results of calculation of Dn−X/2 and those in the case where Y is less than 8 are shown in parentheses. Further, the case where the magnetic cores are adjacent cores, numerical values are indicated in boldface type. Further, n=0 shows the case where there is no magnetic core 7a at the widthwise center.

As shown in Table 1, in the case where an A4-sized range of 297 mm is intended to be heated, 16 magnetic cores 7a from the center (i.e., 32 magnetic cores 7a in total in both sides with a width of about 320 mm) are moved toward the exciting coil 6, and other magnetic cores 7a are moved away from the exciting coil 6.

The magnetic core located at each of ends of a set range in which the magnetic cores are moved toward the fixing belt is the magnetic core of n=15. An inside edge of the magnetic core of n=15 is the outside of a recording material passing range. The magnetic core of n=14 located inside and adjacent to the magnetic core of n=15 opposes a position where the edge of the recording material (A4 size) passes. That is, of the magnetic cores in the set range, the magnetic core located outside the recording material passing range is only the magnetic core of n=15.

As shown in Table 1, e.g., in the case of 13 inch size, a magnetic circuit forming region ranges from the edge of the recording material to a position outwardly distant from the edge by 10.4 mm. For that reason, a degree of temperature lowering (FIG. 10) is decreased and therefore an occurrence of uneven glossiness in the neighborhood of the recording material edge is suppressed.

In this case, the magnetic core located at each of ends of the set range is the magnetic core of n=16. The magnetic core of n=15 is located outside the recording material passing range. The magnetic core of n=15 located inside and adjacent to the magnetic core of n=16 opposes the passing range in which the recording material (13 inch) passes. That is, of the magnetic cores in the set range, the magnetic core located outside the recording material passing range is only the magnetic core (n=16) located at each of the ends.

Also with respect to any paper width other than those shown in Table 1, it is possible to determine the position of the magnetic core 7a by a relational expression (2).

Dn−X/2<Y (2)

Incidentally, the width of the magnetic core 7a may also be a value other than 10 mm. Further, even when the length of each of the magnetic cores 7a is not uniform with respect to the widthwise direction of the fixing belt 1, it is possible to determine, by the relational expression (2), whether or not the magnetic core 7a is moved toward the exciting coil 6.

As shown in FIG. 11 with reference to FIG. 2, when the controller 102 receives a print start command (S11), the controller 102 obtain recording material width information from an operating portion 103 (S12). The controller 102 calculates the position of a Dn-th magnetic core 7a on the basis of an obtained X and a tabulated Y (Table 1) (S13). The controller 102 determines, on the basis of the expression (2), whether or not the position of the Dn-th magnetic core 7a is moved from a current position (S14).

Dn−X/2<Y (2)

In addition to the magnetic core obtained by the above calculation, two magnetic cores each located outside the range are determined as the magnetic cores for forming the magnetic circuit.

In the case where the magnetic core is moved (YES of S14), the controller 102 moves the magnetic cores 7a determined as the magnetic cores for forming the magnetic circuit to a close position of 0.5 mm from the exciting coil 6. Other magnetic cores 7a are moved to a separated position of 10 mm from the exciting coil 6 (S15). That is, before an image heating operation is started, the magnetic cores located outside the set range are moved away from the fixing belt. In order to obtain the heating region suitable for the recording material size, at the non-sheet-passing portion, the gap between the exciting coil 6 and the magnetic cores 7a is increased, and the magnetic cores 7a are moved so as to lower the heat generation efficiency. In Embodiment 1, a movement distance is 10 mm.

After, the positioning of the magnetic cores 7a is ended, electric power supply to the exciting coil 6 is started (S16). When the temperature of the fixing belt 1 is lower than the control temperature (NO of S16), the pressing roller 2 is rotationally driven (S17), so that the electric power supply to the exciting coil 6 is continued to increase the temperature of the fixing belt 1 (S18). Thereafter, when the detected temperature TH1 reaches the control temperature (YES of FIG. 16), a printing operation is started (S19). When one job for the image heating operation is ended, the magnetic cores located outside the set range are returned to a home position where they approach the fixing belt.

As shown in FIG. 12, an occurrence state of the non-sheet-passing portion transfer was compared between the case where the magnetic cores 7a are arranged as in Embodiment 1 and, as Comparative Embodiment, the case where all of the magnetic cores 7a are moved toward the exciting coil 6 to make the heat generation width of the fixing belt 1 maximum. A condition is immediately after an A3-sized plain paper of 105 g/m² in basis weight is subjected to continuous sheet passing of 500 sheets in one job in an environment of 15° C. in ambient temperature and 15% in relative humidity.

According to the non-sheet-passing portion heating control in Embodiment 1, the arrangement of the contacts 7a is optimized to make the heat generation width more than the sheet passing width by one magnetic core 7a in each of both sides of the sheet passing width, so that the range in which the non-sheet-passing portion transfer occurs is minimized. Thus, compared with Comparative Embodiment, in Embodiment 1, an effect of suppressing a maximum temperature by about 20° C. was confirmed.

According to the non-sheet-passing portion heating control in Embodiment 1, the plurality of the divided magnetic cores 7a with respect to the widthwise direction of the fixing belt 1 are independently movable in a direction in which the gap between the exciting coil 6 and the magnetic core 7a is changed. Further, the range enlarged from the recording material length by one magnetic core 7a at each of the outsides of the recording material with respect to the widthwise direction of the fixing belt 1 is heated, so that even when the non-sheet-passing portion transfer does not occur, it is possible to fix the toner image in the entire region of the recording material under a flat temperature condition. As a result, even in printing of several sheets from start of the printing, it is possible to ensure a fixing property of an edge portion of a borderless print. At the end portion of the recording material, the uneven glossiness and improper fixing are prevented from occurring. By controlling the number of the magnetic cores moved depending on the recording material size, even when many types of the recording material size are used, it is possible to heat only a range substantially equal to the recording material size. It is possible to alleviate the non-sheet-passing portion transfer while keeping the temperature of the sheet passing region at a fixable temperature.

Further, when the image heating operation of a predetermined number of sheets of the recording material is completed, it is desirable that the magnetic cores at both ends of the set range are moved toward the fixing belt. As a result, it is possible to suppress excessive transfer at the outside of the recording material.

Incidentally, the control is not limited to the control by a single controller 102 but may also be effected by a plurality of controllers.

According to the non-sheet-passing portion heating control in this embodiment, without relying on the non-sheet-passing portion transfer after the start of the continuous sheet passing, from the start of the continuous sheet passing, the temperature necessary to heat the image is ensured also in the recording material edge region. Therefore, the lowering in glossiness in the region close to the edges of the output image while suppressing the non-sheet-passing portion transfer of the fixing belt.

Incidentally, in this embodiment, a constitution in which the magnetic cores located in the entire widthwise region are movable to the magnetic flux inducing position and the retracted position is employed. However, the present invention is not intended to be limited to this constitution. It is also possible to employ a constitution in which the magnetic cores located in a region in which a minimum-sized recording material with respect to the widthwise direction are fixed and the magnetic cores located in other regions are movable.

Incidentally, in this embodiment, a premium is placed on simplification of the moving mechanism, so that all of the magnetic cores 7a in the set range provide a first gap which is the gap with the coil.

However, the present invention is not intended to be limited to this constitution. There is, there can be the case where a constitution in which a further premium is placed on the suppression of the transfer at the outside of the recording material edge. In this case, of all of the magnetic cores 7a in the set range, with respect to the magnetic cores 7a in the recording material passing region, the gap with the coil is in the first gap. In addition, of the magnetic cores 7a in the set range, with respect to the magnetic cores at both ends, the gap with the coil can also be a gap which is larger than the first gap but is smaller than a second gap. That is, it is also possible to employ a constitution in which the magnetic cores 7a are disposed at the magnetic flux inducing position in the recording material passing region and the magnetic core 7a located closest to the recording material edge is disposed at an intermediate position between the magnetic flux inducing position and the retracted position. However, in this case, the intermediate position may desirably be set at a position closer to the magnetic flux inducing position than the retracted position so that the magnetic core can form the magnetic circuit for guiding the magnetic flux to the fixing member even at the intermediate position.

### Embodiment 2

As shown in FIG. 8 with reference to FIG. 7, in this embodiment, an image forming range is set inside the recording material. Correspondingly to this, the core moving mechanism 71 determines the positions of the magnetic cores 7a by moving at least one magnetic core 7a located outside each of ends of the image forming range toward the fixing belt 1 in addition to the magnetic cores 7a located in the image forming range with respect to the widthwise direction of the recording material.

As shown in FIG. 2, the controller 102 which is an example of a calculating means calculates an end position of an image formable region on the recording material. The controller 102 determines that the magnetic cores 7a located, in a non-sheet-passing portion region, inside a range set in advance from the end portion position of the calculated image formable region toward the outside are disposed at a magnetic flux inducing position. The controller 102 determines that the magnetic cores 7a located, with respect to the widthwise direction, outside the magnetic cores 7a determined to be disposed at the magnetic flux inducing position are disposed at the retracted position.

The controller 102 sets an inside of margins as an image forming range when the margins are set on the recording material through the operating portion 103. With respect to the recording material for which the image forming range is set, in order to effect the heat generation range control with further high accuracy, the controller 102 executes the discrimination of the magnetic cores 7a in accordance with the following relational expression (3).

Dn−X/2<Y+α (3)

Here, α is a numerical value set depending on a variation in position of the recording material with respect to the widthwise direction of the recording material and the margin setting of the peripheral portions of the recording material. When the image forming apparatus A is used as an example, the variation in position of the recording material with respect to the widthwise direction of the recording material is +3 mm. Therefore, when the margin of the recording material with respect to the widthwise direction of the recording material is set at 3 mm, α is calculated by subtracting the margin from the variation according to the following equation.

α=+3−3=0

Dn−X/2<Y+0

When the recording material margin with respect to the widthwise direction of the fixing belt 1 is set at 10 mm, α is calculated as follows.

α=+3−10=−7

Dn−X/r<Y−7

That is, in the case where the margin is large, the range in which the magnetic cores 7a are close to the exciting coil 6 is narrowed, so that the degree of the non-sheet-passing portion transfer can be further suppressed.

Incidentally, α may also be set in consideration of, e.g., a difference in specifications of the image forming apparatus such that evaluation of image defect at the recording material end portion is somewhat laxer than that at the central portion.

### Embodiment 3

As shown in FIG. 8 with reference to FIG. 7, in this embodiment, the core moving mechanism 71 moves, of the magnetic cores 7a positioned by being moved toward the fixing belt 1, at least one magnetic core located at each of both outside ends of the magnetic cores 7a with respect to the widthwise direction of the fixing belt 1 away from the fixing belt 1.

The controller 102 positions the plurality of magnetic cores 7a at the magnetic flux inducing position and the retracted position to increase the temperature of the fixing belt 1 by the exciting coil 6, thus starting the continuous sheet passing. The controller 102 determines, after start of the continuous sheet passing, that one magnetic core located at each of the both outside ends the magnetic cores 7a disposed at the magnetic flux inducing position is disposed at the retracted position with the non-sheet-passing portion transfer.

As shown in FIG. 2, the controller 102 moves, when the pre-rotation is ended and the continuous sheet passing is started, the outermost magnetic cores of the magnetic cores 7a close to the exciting coil 6 away from the exciting coil 6 during the continuous sheet passing (at the time when the sheet passing of 20th-sheet is ended). As a result, it is possible to make adjustment for suppressing the non-sheet-passing portion transfer due to an increasing in extended amount of the heating range toward the outside of the recording material by the magnetic cores 7a while ensuring the fixing property at both edge portions of the recording material by using advancing non-sheet-passing portion transfer.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 170799/2011 filed Aug. 4, 2011, which is hereby incorporated by reference.

What is claimed is:

1. An image heating apparatus comprising:
a coil;
a heating member for heating a toner image on a recording material by generating heat by magnetic flux generated from said coil;
a plurality of magnetic cores provided and arranged in a widthwise direction of said heating member;
a moving mechanism for moving at least a part of said plurality of magnetic cores so that a gap between the magnetic cores and said heating member is changed; and
a control unit for controlling said moving mechanism, wherein said control unit controls, depending on a size of the recording material, said moving mechanism so that the magnetic cores located outside the magnetic cores in a set range with respect to the widthwise direction are moved away from said heating member,
wherein when the recording material of a predetermined size is conveyed to said image heating apparatus, said control unit controls said moving mechanism so that the magnetic cores, of the magnetic cores in the set range, located outside a recording material passing range with respect to the widthwise direction are only the magnetic cores located at end portions of the set range with respect to the widthwise direction.

2. An apparatus according to claim 1, wherein the magnetic cores located outside the set range is moved away from said heating member before an image heating operation is started.

3. An apparatus according to claim 1, wherein when the recording material is conveyed to said image heating apparatus, the magnetic cores at the end portions are moved away from said heating member more than the magnetic cores opposing the passing range after an image heating operation of the recording material is executed in a predetermined number of sheets.

4. An apparatus according to claim 1, wherein when an image heating job is ended, the magnetic cores located outside the set range are moved toward said heating member.

5. An image heating apparatus comprising:
a coil;
a heating member for heating a toner image on a recording material by generating heat by magnetic flux generated from said coil;
a plurality of magnetic cores provided and arranged in a widthwise direction of said heating member;
a moving mechanism for moving at least a part of said plurality of magnetic cores so that a gap between the magnetic cores and said heating member is changed; and
a control unit for controlling said moving mechanism, wherein said control unit controls, depending on a size of the recording material, said moving mechanism so that the magnetic cores located outside the magnetic cores in a set range with respect to the widthwise direction are moved away from said heating member,
wherein when the recording material of a size is conveyed to said image heating apparatus, said control unit controls said moving mechanism so that the set range is longer in set distance than a recording material passing range with respect to the widthwise direction and so that end portions of the set range are located outside corresponding end portions of the recording material passing range with respect to the widthwise direction.

6. An apparatus according to claim 5, wherein said control unit sets the set distance depending on a length of an image forming region in which an image is formed with respect to the widthwise direction.

7. An apparatus according to claim 6, wherein said control unit decreases the set distance with a shorter length of the image forming region.

8. An apparatus according to claim 5, wherein the magnetic cores located outside the set range is moved away from said heating member before an image heating operation is started.

9. An apparatus according to claim 5, wherein when the recording material is conveyed to said image heating apparatus, the magnetic cores at the end portions are moved away from said heating member more than the magnetic cores opposing the passing range after an image heating operation of the recording material is executed in a predetermined number of sheets.

10. An apparatus according to claim 5, wherein when an image heating job is ended, the magnetic cores located outside the set range are moved toward said heating member.
